(19) United States
(12) Patent Application Publication
(10) Pub. No.: US 2024/0127488 A1
(43) Pub. Date: Apr. 18, 2024

(54) IMAGE TRANSMISSTION METHOD BASED ON ACCUMULATION OF REGION OF INTEREST

(71) Applicants: ELECTRONICS AND TELECOMMUNICATIONS RESEARCH INSTITUTE, Daejeon (KR); MYONGJI UNIVERSITY INDUSTRY AND ACADEMIA COOPERATION FOUNDATION, Yongin-si (KR)

(72) Inventors: Jin Young LEE, Daejeon (KR); Hee Kyung LEE, Daejeon (KR); Sang Kyun KIM, Yongin-si (KR)

(21) Appl. No.: 18/485,772

(22) Filed: Oct. 12, 2023

(30) Foreign Application Priority Data
Oct. 13, 2022 (KR) 10-2022-0131751
Jul. 11, 2023 (KR) 10-2023-0089683

(51) Int. Cl. G06T 9/00; G06T 7/11; G06T 7/62; G06V 10/25

(52) U.S. Cl. CPC G06T 9/00; G06T 7/11; G06T 7/62; G06V 10/25; G06V 2201/07

(57) ABSTRACT

An image encoding/decoding method, device and recording medium based on accumulation of a region of interest of the present disclosure may include partitioning a current image to acquire a region of interest, cumulatively expressing the region of interest in a reference image of the current image and decoding the current image based on a reference image in which the region of interest is cumulatively expressed.

### CROSS-REFERENCE TO RELATED APPLICATIONS

This application claims the benefit of earlier filing date and right of priority to Korean Application NO. 10-2022-0131751, filed on Oct. 13, 2022, and priority to Korean Application NO. 10-2023-0089683, filed on Jul. 11, 2023, the contents of which are all hereby incorporated by reference herein in their entirety.

### TECHNICAL FIELD

The present disclosure relates to an image encoding/decoding method, device and recoding medium based on a region of interest.

### BACKGROUND ART

A main purpose of the existing image compression technology was to increase a compression rate while maintaining the best quality for human beings to see. But, in a recent industrial field, a purpose of required image acquisition and transmission is frequently to perform a specific task, not what is good for human beings to see. In this case, a goal of image compression is to increase a compression rate while maintaining accuracy of a specific task as much as possible.

### DISCLOSURE

### Technical Problem

The present disclosure provides a method, a device and a recording medium of encoding/decoding an image.

### Technical Solution

An image encoding/decoding method, device and recording medium based on accumulation of a region of interest of the present disclosure may include partitioning a current image to acquire a region of interest, cumulatively expressing the region of interest in a reference image of the current image and encoding or decoding the current image based on a reference image in which the region of interest is cumulatively expressed.

In an image encoding/decoding method, device and recording medium based on accumulation of a region of interest of the present disclosure, the partition may partition the current image into at least one region of interest and at least one region of non-interest and the partition may be performed based on at least one of position information or size information of a region of interest.

In an image encoding/decoding method, device and recording medium based on accumulation of a region of interest of the present disclosure, a type of a partitioned region of the current image may be determined through machine learning-based object search and the type may include a region of interest and a region of non-interest.

In an image encoding/decoding method, device and recording medium based on accumulation of a region of interest of the present disclosure, a type of a region determined through the object search may be redetermined by comparing whether it is the same as a type of a collocated region in another image belonging to a picture group.

In an image encoding/decoding method, device and recording medium based on accumulation of a region of interest of the present disclosure, the region of interest may include a first region of interest obtained by partitioning the current region and a second region of interest obtained by mapping the first region of interest in a predetermined block unit.

In an image encoding/decoding method, device and recording medium based on accumulation of a region of interest of the present disclosure, the predetermined block unit may be any one of the largest coding unit, the smallest coding unit, a coding unit or a sub-coding unit.

In an image encoding/decoding method, device and recording medium based on accumulation of a region of interest of the present disclosure, the current image may be all or some images which refer to the reference image among images belonging to a picture group.

In an image encoding/decoding method, device and recording medium based on accumulation of a region of interest of the present disclosure, the cumulatively expressed region of interest may include a first region of interest including a first object of a first image and a second region of interest including a second object of a second image, the first image and the second image may be an image which refers to the reference image and the second object may be an object which is not subject to object search in the first image.

### Technical Effects

According to the present disclosure, compression and transmission efficiency may be improved by transmitting only a region of interest of an image in order to perform a specific task.

### DESCRIPTION OF DRAWINGS

FIG. 1 is a conceptual diagram for an image encoding and decoding system according to an embodiment of the present disclosure.

FIG. 2 is a block diagram for an image encoding device according to an embodiment of the present disclosure.

FIG. 3 is a block diagram for an image decoding device according to an embodiment of the present disclosure.

FIG. 4 is a diagram showing an image encoding method according to the present disclosure.

FIG. 5 is a diagram showing an example in which a region of interest is mapped to a region in a predetermined block unit.

FIG. 6 is a diagram showing an image decoding method according to the present disclosure.

### BEST MODE

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference sign is used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term, and/or, includes a combination of a plurality of relative entered items or any item of a plurality of relative entered items.

When a component is referred to as being “linked” or “connected” to other component, it should be understood that it may be directly linked or connected to other component, but other component may exist in the middle. On the other hand, when a component is referred to as being “directly linked” or “directly connected” to other component, it should be understood that other component does not exist in the middle.

As a term used in this application is only used to describe a specific embodiment, it is not intended to limit the present disclosure. Expression of the singular includes expression of the plural unless it clearly has a different meaning contextually. In this application, it should be understood that a term such as “include” or “have”, etc. is to designate the existence of features, numbers, steps, motions, components, parts or their combinations entered in a specification, but is not to exclude the existence or possibility of addition of one or more other features, numbers, steps, motions, components, parts or their combinations in advance.

An image according to the present disclosure may mean one frame (or picture) or may mean a segment smaller than a frame, i.e., a subpicture, a slice, a tile or a coding tree unit. For convenience of a description, it is assumed that the following image is one frame.

Configuration information or a syntax element required in an image encoding process may be determined at a unit level such as a video, a sequence, a picture, a sub-picture, a slice, a tile, a coding tree unit block, etc., which may be included in a bitstream and transmitted to a decoder in a unit such as a video parameter set (VPS), a sequence parameter set (SPS), a picture parameter set (PPS), a slice header, a tile header, a block header, etc., and in a decoder, configuration information which is parsed in a unit at the same level and transmitted from an encoder may be reconstructed and used in an image decoding process. In addition, related information may be transmitted in a bitstream, parsed and used in a form of Supplement Enhancement Information (SEI) or metadata, etc. Each parameter set has a unique ID value and a lower parameter set may have a ID value of a higher parameter set to be referred to. For example, a lower parameter set may refer to information of a higher parameter set with a matching ID value among one or more higher parameter sets. Among examples of various units mentioned above, a unit corresponding to a case when one unit includes one or more other units may be referred to as a higher unit and an included unit may be referred to as a lower unit.

For configuration information generated in the unit, it may include contents about an independent configuration per corresponding unit or may include contents about a configuration dependent on a previous, subsequent or higher unit, etc. Here, a dependent configuration may be understood as representing configuration information in a corresponding unit as flag information following a configuration in a previous, subsequent or higher unit (e.g., for a 1-bit flag, if it is 1, it is followed and if it is 0, it is not followed). Configuration information in the present disclosure will be described based on an example of an independent configuration, but an example of addition or replacement as contents about a relationship dependent on configuration information in a previous, subsequent or higher unit of a current unit.

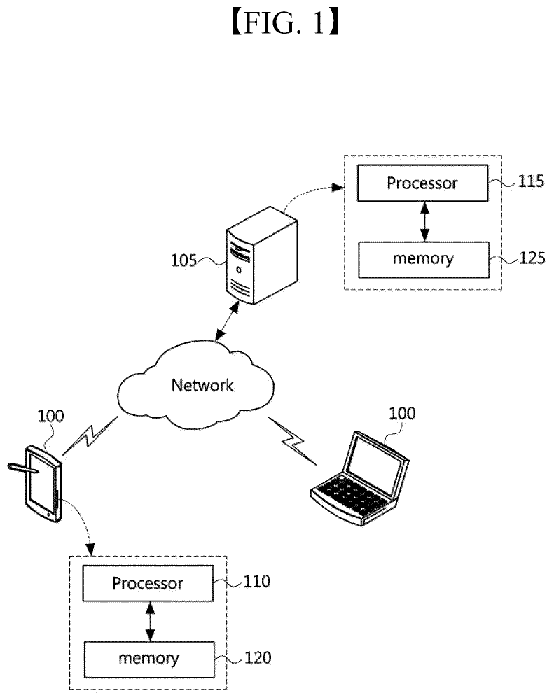

FIG. 1 is a conceptual diagram for an image encoding and decoding system according to an embodiment of the present disclosure.

In reference to FIG. 1, an image encoding device 105 and decoding device 100 may be a user terminal such as a personal computer (PC), a laptop computer, a personal digital assistant (PDA), a portable multimedia player (PMP), a PlayStation portable (PSP), a wireless communication terminal, a smart phone, a TV, etc. or a server terminal such as an application server and a service server, etc. and may include a variety of devices equipped with a communication device such as a communication modem, etc. for communicating with various devices or wired and wireless communication networks, a memory 120 and 125 for storing various programs and data for inter or intra prediction to encode or decode an image, a processor 110 and 115 for executing a program to perform operation and control and others. In addition, an image encoded in a bitstream by an image encoding device 105 may be transmitted to an image decoding device 100 through various communication interfaces such as a cable, a universal serial bus (USB), etc. or through a wired or wireless network, etc. such as a inter-network, a wireless local area network, a wireless LAN network, a wibro network, a mobile communication network, etc. in real or non-real time and may be decoded in an image decoding device 100, reconstructed into an image and regenerated. In addition, an image encoded in a bitstream by an image encoding device 105 may be transmitted from an image encoding device 105 to an image decoding device 100 through a computer readable recording medium.

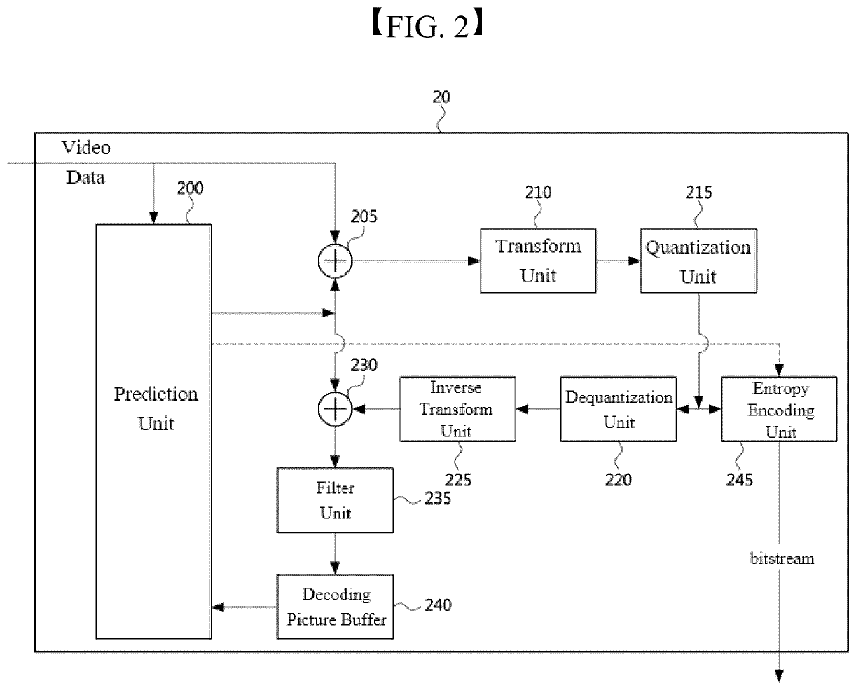

FIG. 2 is a block diagram for an image encoding device according to an embodiment of the present disclosure.

An image encoding device according to this embodiment may encode and transmit the entire image or may encode and transmit only a partial region in an image. Here, a partial region may mean a region required for a specific task (hereinafter, referred to as a region of interest). An image encoding device according to this embodiment may encode encoding/decoding configuration information representing whether the entire image is encoded or only a part in an image is encoded in a bitstream and transmit it to a decoder.

An image encoding device 20 according to this embodiment, as shown in FIG. 2, may include a prediction unit 200, a subtraction unit 205, a transform unit 210, a quantization unit 215, a dequantization unit 220, an inverse transform unit 225, an addition unit 230, a filter unit 235, a decoding picture buffer 240 and an entropy encoding unit 245.

A prediction unit 200 may include an intra prediction unit which performs an intra prediction technique and an inter prediction unit which performs an inter prediction technique to encode an image. Here, an intra prediction technique may refer to an encoding method using a correlation between regions in a frame. An inter prediction technique may refer to a method of performing encoding by referring to a previous frame and/or a subsequent frame on a time axis in a group of pictures (GOP) that a corresponding frame exists based on a frame to be encoded. Whether to use an intra prediction technique or an inter prediction technique for an encoding unit or a prediction unit may be determined and specific information according to each prediction method (e.g., a prediction mode, a motion vector, a reference frame, etc.) may be determined. In this case, a processing unit that prediction is performed and a processing unit that a prediction method and specific contents are determined may be determined according to an encoding/decoding configuration. As an example, a processing unit that prediction is performed may be a lower unit than a processing unit that a prediction method and specific contents are determined.

A subtraction unit 205 subtracts a prediction block from a current block to generate a residual block. In other words, a subtraction unit 205 calculates a difference between a pixel value of each pixel of a current block to be encoded and a prediction pixel value of each pixel of a prediction block generated through a prediction unit to generate a residual block which is a residual signal in a form of a block.

A transform unit 210 transforms a residual block into a frequency domain to transform each pixel value of a residual block into a frequency coefficient. Here, a transform unit 210 may transform a residual signal into a frequency domain by using a variety of transform techniques which transform an image signal on a spatial axis into a frequency axis such as hadamard transform, discrete cosine transform based transform (DCT Based Transform), discrete sine transform based transform (DST Based Transform), Karhunen Loeve transform based transform (KLT Based Transform), etc., and a residual signal transformed into a frequency domain becomes a frequency coefficient. Transform may be transformed by a one-dimensional transform matrix. Each transform matrix may be used adaptively in a horizontal or vertical unit. For example, for intra prediction, when a prediction mode is horizontal, a DCT based transform matrix may be used in a vertical direction and a DST based transform matrix may be used in a horizontal direction. When a prediction mode is vertical, a DCT based transform matrix may be used in a horizontal direction and a DST based transform matrix may be used in a vertical direction.

A quantization unit 215 quantizes a residual block having a frequency coefficient transformed into a frequency domain by a transform unit 210. Here, a quantization unit 215 may quantize a transformed residual block by using dead zone uniform threshold quantization, quantization weighted matrix or an improved quantization technique, etc. It may have one or more quantization techniques as a candidate and may be determined by an encoding mode, prediction mode information, etc.

An entropy encoding unit 245 scans a generated quantization frequency coefficient sequence according to a variety of scan methods to generate a quantization coefficient sequence and uses an entropy encoding technique, etc. to encode and output it. A scan pattern may be configured as one of various patterns such as zigzag, diagonal, raster, etc.

A dequantization unit 220 dequantizes a residual block quantized by a quantization unit 215. In other words, a quantization unit 220 dequantizes a quantization frequency coefficient sequence to generate a residual block having a frequency coefficient.

An inverse transform unit 225 inversely transforms a residual block which is dequantized by a dequantization unit 220. In other words, an inverse transform unit 225 inversely transforms frequency coefficients of a dequantized residual block to generate a residual block having a pixel value, i.e., a reconstructed residual block. Here, an inverse transform unit 225 may perform inverse transform by inversely using a transform method used in a transform unit 210.

An addition unit 230 reconstructs a current block by adding a prediction block predicted by a prediction unit 200 and a residual block reconstructed by an inverse transform unit 225. A reconstructed current block may be stored as a reference picture (or a reference block) in a decoding picture buffer 240 and may be used as a reference picture when encoding a next block of a current block or other block or other picture in the future.

A filter unit 235 may include one or more post-processing filter processes such as a deblocking filter, a sample adaptive offset (SAO), an adaptive loop filter (ALF), etc. A deblocking filter may remove block distortion generated at a boundary between blocks in a reconstructed picture. An ALF may perform filtering based on a value obtained by comparing a reconstructed image with an original image after a block is filtered through a deblocking filter. A SAO reconstructs an offset difference from an original image in a pixel unit for a residual block to which a deblocking filter is applied and may be applied in a form of a band offset, an edge offset, etc. This post-processing filter may be applied to a reconstructed picture or block.

A decoding picture buffer 240 may store a block or a picture reconstructed through a filter unit 235. A reconstructed block or picture stored in a decoding picture buffer 240 may be provided to a prediction unit 200 which performs intra prediction or inter prediction.

Although not shown in a drawing, a partition unit may be further included and partition may be performed in an encoding unit of various sizes through a partition unit. In this case, an encoding unit may be configured with a plurality of encoding blocks according to a color format (e.g., one luma encoding block, two chroma encoding blocks, etc.). For convenience of a description, it is described by assuming one color component unit. An encoding block may have a variable size such as M×M (e.g., M is 4, 8, 16, 32, 64, 128, etc.). Alternatively, an encoding block may have a variable size such as M×N (e.g., M and N are 4, 8, 16, 32, 64, 128, etc.) according to a partition method (e.g., tree based partition, quad tree partition, binary tree partition, etc.). In this case, an encoding block may be a basic unit for intra prediction, inter prediction, transform, quantization, entropy encoding, etc.

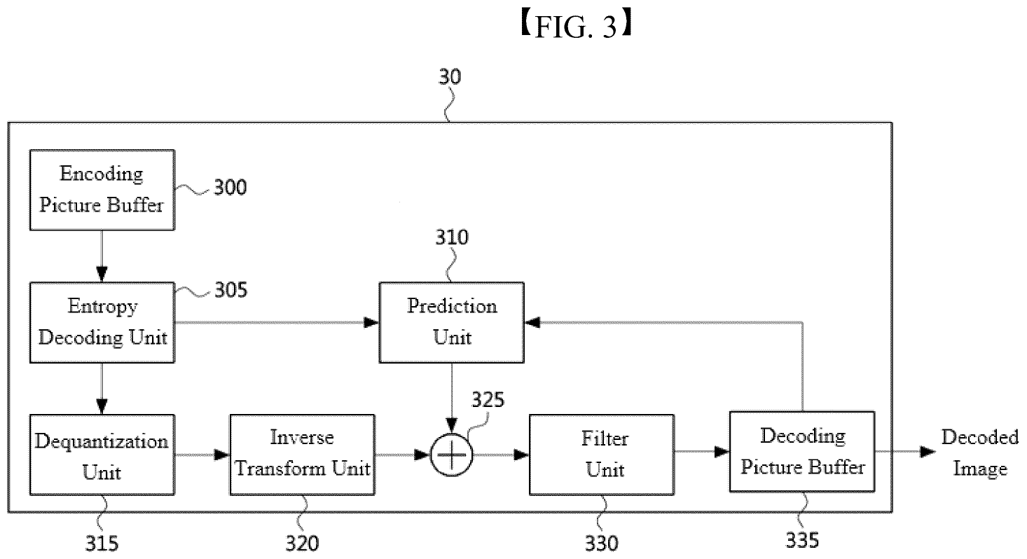

FIG. 3 is a block diagram for an image decoding device according to an embodiment of the present disclosure.

An image decoding device according to this embodiment may decode and transmit the entire image or decode and transmit only a partial region in an image. Here, a partial region may mean a region required for a specific task (hereinafter, referred to as a region of interest). An image decoding device according to this embodiment may determine whether to decode the entire image or only a part in an image according to encoding/decoding configuration information signaled from a bitstream.

In reference to FIG. 3, an image decoding device 30 may be configured by including an encoding picture buffer 300, an entropy decoding unit 305, a prediction unit 310, a dequantization unit 315, an inverse transform unit 320, an addition and subtraction unit 325, a filter 330 and a decoding picture buffer 335.

First, when an image bitstream transmitted from an image encoding device 20 is received, it may be stored in an encoding picture buffer 300.

An entropy decoding unit 305 may decode a bitstream to generate quantized coefficients, motion vectors and other syntax. Generated data may be transmitted to a prediction unit 310.

A prediction unit 310 may generate a prediction block based on data transmitted from an entropy decoding unit 305. In this case, based on a reference image stored in a decoded picture buffer 335, a reference picture list using a default configuration technique may be configured.

A prediction unit 310 may include an intra prediction unit which performs an intra prediction technique and an inter prediction unit which performs an inter prediction technique to decode an image. Here, an intra prediction technique may refer to a decoding method using a correlation between regions in a frame. An inter prediction technique may refer to a method of performing decoding by referring to a previous frame and/or a subsequent frame on a time axis in a group of pictures (GOP) that a corresponding frame exists based on a frame to be decoded. Whether to use an intra prediction technique or an inter prediction technique for a decoding unit or a prediction unit may be determined and specific information according to each prediction method (e.g., a prediction mode, a motion vector, a reference frame, etc.) may be determined. In this case, a processing unit that prediction is performed and a processing unit that a prediction method and specific contents are determined may be determined according to an encoding/decoding configuration. As an example, a processing unit that prediction is performed may be a lower unit than a processing unit that a prediction method and specific contents are determined.

A dequantization unit 315 may be provided to a bitstream to dequantize quantized transform coefficients decoded by an entropy decoding unit 305.

An inverse transform unit 320 may generate a residual block by applying inverse DCT, inverse integer transform or similar inverse transform techniques to a transform coefficient.

In this case, a dequantization unit 315 and an inverse transform unit 320 may be implemented in a variety of ways while inversely performing a process performed in a transform unit 210 and a quantization unit 215 of an image encoding device 20 described above. For example, the same process and inverse transform shared with a transform unit 210 and a quantization unit 215 may be used or a transform and quantization process may be inversely transformed by using information about a transform and quantization process (e.g., a transform size, a transform shape, a quantization type, etc.) from an image encoding device 20.

A residual block which goes through a dequantization and inverse transform process may be added to a prediction block derived by a prediction unit 310 to generate a reconstructed image block. Such addition may be performed by an addition and subtraction unit 325.

A filter 330 may apply a deblocking filter to a reconstructed image block to remove blocking if necessary or may additionally use other loop filters before and after the decoding process to improve video quality.

An image block which goes through reconstruction and filtering may be stored in a decoding picture buffer 335.

Machine learning may be used to extract a region of interest from an image, and in this case, according to performance of machine learning, all regions of interest in an image may not be extracted. In particular, for a case in which a region of interest of a current image is encoded by an inter prediction technique, if there is no region of interest corresponding to a reference image of a current image, a region of interest of a current image performs encoding by an intra prediction technique and further, a problem occurs in which an encoding bit rate increases.

To prevent this problem, a probability of an inter prediction technique may be improved by accumulating and expressing a region of interest extracted from each image in a picture group in one or more images belonging to a picture group.

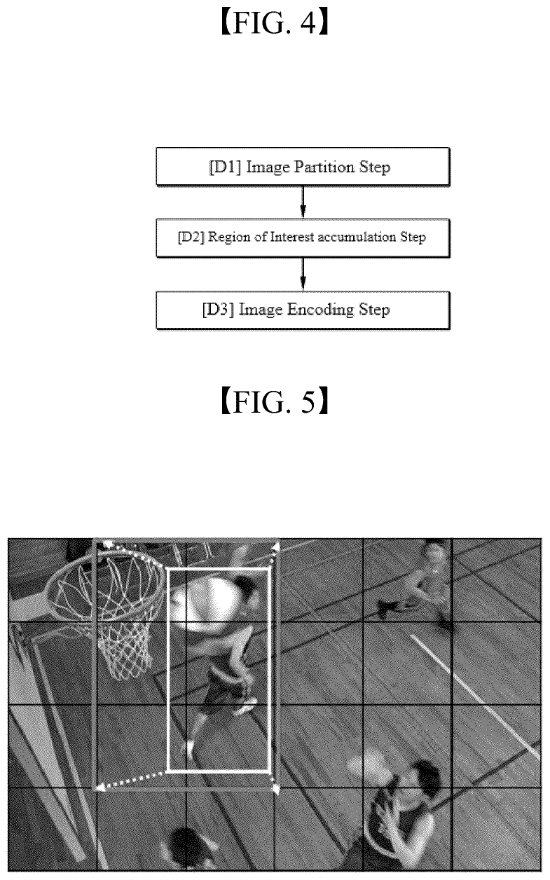

FIG. 4 is a diagram showing an image encoding method according to the present disclosure.

An image encoding method according to the present disclosure may include at least one of [D1] an image partition step, [D2] a region of interest accumulation step or [D3] an image encoding step. In other words, an image encoding method according to the present disclosure may perform all of steps [D1] to [D3] described above or some steps may be omitted.

[D1] Image Partition Step

One image may be partitioned into one or more regions of interest and one or more regions of non-interest. In order to partition the image into one or more regions of interest and one or more regions of non-interest, at least one of position information or size information of a region of interest and/or a region of non-interest may be derived.

Specifically, through machine learning based object search, a region of interest and a region of non-interest may be specified and at least one of position information or size information of each region may be derived. Based on at least one of type information representing whether a type of a corresponding region is a region of interest or a region of non-interest, position information of each region or size information of each region, the image may be partitioned into at least one region of interest and at least one region of non-interest.

The position information may be obtained for each region of interest and may be obtained for each region of non-interest. Alternatively, the position information may be obtained only for a region of interest and may not be obtained for a region of non-interest. Similarly, the size information may be obtained for each region of interest and may be obtained for each region of non-interest. Alternatively, the size information may be obtained only for a region of interest and may not be obtained for a region of non-interest.

Specifically, a relative probability that an object exists in each region may be predicted by using a feature value which is output of a deep learning network and based thereon, at least one of type information, position information or size information described above may be determined.

FIG. 5 is a diagram showing an example in which a region of interest is mapped to a region in a predetermined block unit.

The specified region of interest may be mapped (or resized) to a region in a predetermined block unit. Through the mapping, at least one of position information or size information of a corresponding region of interest may be changed.

A predetermined block unit may mean any one of a largest coding unit, a smallest coding unit, a coding unit or a sub coding unit. A region in a predetermined block unit may mean a region entirely configured with the integer number of block units. For example, the region in a block unit may be configured with 1 block unit or may be configured with 2 or more block units.

For example, a position of a top-left sample of the specified region of interest may be changed to a position of a top-left sample in a block unit to which a corresponding top-left sample belongs. Similarly, a position of a bottom-left sample of the specified object region may be changed to a position of a bottom-left sample in a block unit to which a corresponding bottom-left sample belongs. A position of a top-right sample of the specified object region may be changed to a position of a top-right sample in a block unit to which a corresponding top-right sample belongs. A position of a bottom-right sample of the specified object region may be changed to a position of a bottom-right sample in a block unit to which a corresponding bottom-right sample belongs.

Alternatively, a position of a top-left sample of the specified object region may be changed to a position of a top-left sample in a block unit closest to a corresponding top-left sample. Similarly, a position of a bottom-left sample of the specified object region may be changed to a position of a bottom-left sample in a block unit closest to a corresponding bottom-left sample. A position of a top-right sample of the specified object region may be changed to a position of a top-right sample in a block unit closest to a corresponding top-right sample. A position of a bottom-right sample of the specified object region may be changed to a position of a bottom-right sample in a block unit closest to a corresponding bottom-right sample.

In FIG. 5, an example in which a predetermined block unit and a region of interest are rectangular is used, but a predetermined block unit or a region of interest may be other polygon, not a rectangle, so for a polygon, the number of samples whose position is changed may be the same as the number of corners of a polygon or may be smaller than the number of the corners.

The mapping process may be applied equally to a region of non-interest. Alternatively, there may be a limit that the mapping process is not performed for a region of non-interest. Through the above-described mapping process, a size of at least one of a region of interest or a region of non-interest may be enlarged or reduced. Object search may be performed in a block unit described above and in this case, the mapping process may be omitted regardless of whether a type of a region is a region of interest.

Additionally, a type of a region determined through the object search may be redetermined by comparing whether it is the same as a type of a collocated region in other image belonging to a picture group. Alternatively, a type of a region determined through the object search may be redetermined by comparing it to a type of a region corresponding to a region determined through the object search determined based on encoding/decoding information (e.g., a motion vector).

When a type of a current region in a current image is the same as a type of a collocated region in other image, a type of a current region may be maintained as it is. On the other hand, when a type of a current region in a current image is different from a type of a collocated region in other image, a type of a current region may be changed to a different type.

For example, when a type of a current region in a current image is a region of interest and a type of a collocated region in other image is a region of interest, a type of a current region may be maintained as a region of interest. When a type of a current region in a current image is a region of non-interest and a type of a collocated region in other image is a region of non-interest, a type of a current region may be maintained as a region of non-interest.

On the other hand, when a type of a current region in a current image is a region of interest and a type of a collocated region in other image is a region of non-interest, a type of a current region may be changed to a region of non-interest. Alternatively, when a type of a current region in a current image is a region of non-interest and a type of a collocated region in other image is a region of interest, a type of a current region may be changed to a region of interest.

[D2] Region of Interest Accumulation Step

In a reference image, a region of interest of a current image may be cumulatively expressed. Here, a current image may refer to all images which refer to the reference image among images belonging to a picture group. Alternatively, a current image may refer to one or more partial images of all images which refer to the reference image. But, a region of interest of other image may not be cumulatively expressed for an image which is not referred to by other image among images belonging to a picture group.

For example, three objects of interest exist in one or more images, which is referred to as a first object of interest, a second object of interest and a third object of interest, respectively. An object may be searched from an image through machine learning based object search. It is assumed that only a first object of interest is searched in a first image (frame 0), only a third object of interest is searched in a second image (frame 1) and only a second object of interest is searched in a third image (frame 2). In this case, a region including a first object of interest in a first image may be expressed as a first region of interest. In a second image, a region including a third object of interest may be expressed as a third region of interest. In a third image, a region including a second object of interest may be expressed as a second region of interest.

Since a third object of interest is not searched in a first image and a third image, a region including a third object of interest is not expressed as a third region of interest. Accordingly, a third region of interest of a second image may not perform inter prediction referring to at least one of a first image or a third image. In this case, a third region of interest of a second image may be encoded through intra prediction. Compared to a case in which a second object of interest and a third object of interest are searched and marked as a region of interest in a first image, encoding efficiency may decrease, increasing a bit rate.

Accordingly, a region including a second object of interest and a third object of interest searched in a second image and a third image may be marked as a region of interest, respectively. As such, a region of an object of interest searched in other image may be accumulated and marked as a region of interest to enable inter prediction based encoding and improve encoding efficiency to reduce a bit rate.

An accumulation method of a region of interest may vary depending on a method of referring to a previous/subsequent frame in performing inter prediction in an encoding/decoding device.

A sample value of a region excluding a region of interest in a current image and/or a reference image may be transformed into a predetermined sample value (e.g., white, black, etc.), which may improve efficiency of an inter prediction technique.

[D3] Image Encoding Step

Encoding of a current image may be performed based on a reference image that a region of interest of a current image is cumulatively expressed. An encoding method is performed by an encoding device and an encoding method performed by an encoding device is described above, so it is omitted hereinafter.

A bitstream may be generated through the encoding. In an image encoding step, a result of a determination performed in steps [D1] to [D3] may be encoded and inserted into a bitstream.

The bitstream may include encoding/decoding configuration information representing whether encoding/decoding of an image is performed based on a reference image that a region of interest of the current image is cumulatively expressed.

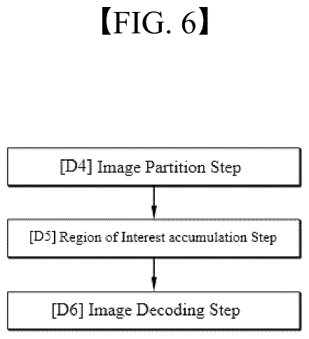

FIG. 6 is a diagram showing an image decoding method according to the present disclosure.

An image decoding method according to the present disclosure may include at least one of [D4] an image partition step, [D5] a region of interest accumulation step or [D6] an image decoding step. In other words, an image decoding method according to the present disclosure may perform all of steps [D4] to [D6] described above or some steps may be omitted.

In an image decoding method according to the present disclosure, an image partition step and a region of interest accumulation step may be the same as an image encoding method. In other words, an image partition step and a region of interest accumulation step are described in an image encoding method, so they are omitted hereinafter.

In addition, an image decoding method is performed by a decoding device and a decoding method performed by a decoding device is described above, so it is omitted hereinafter.

When embodiments described based on a decoding process or an encoding process are applied to an encoding process or a decoding process, it is included in a scope of the present disclosure. When embodiments described in predetermined order are changed in order different from a description, it is also included in a scope of the present disclosure.

The above-described disclosure is described based on a series of steps or flow charts, but it does not limit time series order of the present disclosure and if necessary, it may be performed at the same time or in different order. In addition, each component (e.g., a unit, a module, etc.) configuring a block diagram in the above-described disclosure may be implemented as a hardware device or software and a plurality of components may be combined and implemented as one hardware device or software. The above-described disclosure may be recorded in a computer readable recoding medium by being implemented in a form of a program instruction which may be performed by a variety of computer components. The computer readable recoding medium may include a program instruction, a data file, a data structure, etc. solely or in combination. An example of a computer readable recoding medium includes magnetic media such as a hard disk, a floppy disk and a magnetic tape, optical recording media such as a CD-ROM and a DVD, magneto-optical media such as a floptical disk and a hardware device which is specially configured to store and execute a program instruction such as ROM, RAM, a flash memory, etc. The hardware device may be configured to operate as at least one software module in order to perform processing according to the present disclosure and vice versa. A device according to the present disclosure may have a program instruction for storing or transmitting a bitstream generated by the above-described encoding method.

What is claimed is:

1. An image decoding method based on accumulation of a region of interest, the image decoding method comprising:
partitioning a current image to obtain the region of interest;
cumulatively expressing the region of interest in a reference image of the current image; and
decoding the current image based on the reference image in which the region of interest is cumulatively expressed.

2. The method of claim 1,
wherein the partition partitions the current image into at least one region of interest and at least one region of non-interest, and
wherein the partition is performed based on at least one of position information or size information of the region of interest.

3. The method of claim 2,
wherein a type of a partitioned region of the current image is determined through machine learning-based object search, and
wherein the type includes the region of interest and the region of non-interest.

4. The method of claim 3,
wherein the type of the region determined through the object search is redetermined by comparing whether it is the same as a type of a collocated region in another image belonging to a picture group.

5. The method of claim 1,
wherein the region of interest includes a first region of interest obtained by partitioning the current region and a second region of interest obtained by mapping the first region of interest in a predetermined block unit.

6. The method of claim 5,
wherein the predetermined block unit is any one of a largest coding unit, a smallest coding unit, a coding unit or a sub-coding unit.

7. The method of claim 1,
wherein the current image is all images or some images which refer to the reference image among images belonging to a picture group.

8. The method of claim 7,
wherein the cumulatively expressed region of interest includes a first region of interest including a first object of a first image and a second region of interest including a second object of a second image,
wherein the first image and the second image are the image which refers to the reference image, and
wherein the second object is an object which is not subject to object search in the first image.

9. An image encoding method based on accumulation of a region of interest, the image encoding method comprising:
partitioning a current image to obtain the region of interest;
cumulatively expressing the region of interest in a reference image of the current image; and
encoding the current image based on the reference image in which the region of interest is cumulatively expressed.

10. The method of claim 9,
wherein the partition partitions the current image into at least one region of interest and at least one region of non-interest, and
wherein the partition is performed based on at least one of position information or size information of the region of interest.

11. The method of claim 10,
wherein a type of a partitioned region of the current image is determined through machine learning-based object search, and
wherein the type includes the region of interest and the region of non-interest.

12. The method of claim 11,
wherein the type of the region determined through the object search is redetermined by comparing whether it is the same as the type of a collocated region in another image belonging to a picture group.

13. The method of claim 9, wherein:
wherein the region of interest includes a first region of interest obtained by partitioning the current region and a second region of interest obtained by mapping the first region of interest in a predetermined block unit.

14. The method of claim 13,
wherein the predetermined block unit is any one of a largest coding unit, a smallest coding unit, a coding unit or a sub-coding unit.

15. The method of claim 9,
wherein the current image is all images or some images which refer to the reference image among images belonging to a picture group.

16. The method of claim 15,
wherein the cumulatively expressed region of interest includes a first region of interest including a first object of a first image and a second region of interest including a second object of a second image,
wherein the first image and the second image are the image which refers to the reference image, and
wherein the second object is an object which is not subject to object search in the first image.

17. A computer readable recording medium storing a bitstream generated by an image encoding method based on accumulation of a region of interest, wherein the image encoding method includes:
partitioning a current image to obtain the region of interest;
cumulatively expressing the region of interest in a reference image of the current image; and
encoding the current image based on the reference image in which the region of interest is cumulatively expressed.
